(19) United States
(12) Patent Application Publication
(10) Pub. No.: US 2020/0056829 A1
(43) Pub. Date: Feb. 20, 2020

(54) Refrigerator Hinge

(71) Applicant: JIANGSU SACA PRECISION TECHNOLOGY CO., LTD, Taizhou (CN)

(72) Inventors: Gengxi Cai, Foshan (CN); Xiang Zhang, Fuyang (CN); Hesheng Huang, Foshan (CN); Wenming Yang, Singapore (SG)

(21) Appl. No.: 16/597,885

(22) Filed: Oct. 10, 2019

Related U.S. Application Data
(63) Continuation of application No. PCT/CN2018/080070, filed on Mar. 22, 2018.

(30) Foreign Application Priority Data
Apr. 10, 2017 (CN) 201710227664.5

(51) Int. Cl. F25D 23/02; E05D 3/06; E05D 5/02; E05F 5/08

(52) U.S. Cl. CPC F25D 23/028; E05D 3/06; E05D 5/0215; F25D 2323/024; E05Y 2900/31; E05Y 2600/632; E05F 5/08

(57) ABSTRACT

The present invention provides an improved refrigerator hinge, comprising a fixed base and a hinge seat, and a hinge assembly arranged between the fixed base and the hinge seat, wherein the hinge assembly comprises a first transmission arm, a second transmission arm, a back transmission arm and a lower transmission arm; the first transmission arm is provided with an elastic buffer device, and the buffer head acts at the buffer end of the elastic buffer device for linear buffer; the fixing base is integrated with more than one assembling plate; and when the hinge is open, the second transmission arm is spanned between the fixed base and the hinge seat. The improved refrigerator hinge of the present invention has the advantages of stable and reliable performance, simple and reasonable structure and effective prevention of accumulation of water vapor, dirt and the like.

### TECHNICAL FIELD

The present invention relates to a transmission component of a hinge, particularly to an improved refrigerator hinge.

### BACKGROUND

A refrigerator hinge is the most commonly used connecting piece for rotatably opening a refrigerator door. In order to achieve good closing performance between the refrigerator door after opening or closing and the refrigerator cabinet, the existing refrigerator hinge usually adopts a six-link transmission mechanism. However, the current refrigerator hinge has the following disadvantages: 1. The elastic buffer is arranged in the back transmission arm and is pushed to operate by a lug boss on the hinge seat, when the back transmission arm rotates, the rotating shaft of the lug boss is always in a fixed state, so that when being pressed, the spring is affected by the radial stress, and then is prone to radial deformation and uneven stress; 2. Both the locating piece and the fixed base are separately arranged, the fixed base can only be fixed to the refrigerator frame by the locating piece, which not only causes low assembling efficiency due to multiple assembling procedures, but also causes difficulty in guaranteeing the assembling strength, moreover, moreover, looseness may be caused due to errors, affecting the usage experience; and 3. There are fewer moment arms for rotating the hinge seat, resulting in relatively large thrust required for the rotation of the refrigerator door and inconvenient operation, and there are many connecting points inside the hinge, easily resulting in accumulation of water vapor, dirt and the like. Therefore, the traditional refrigerator hinge still needs further improvement.

### SUMMARY

To overcome the defect of the prior art, the present invention provides an improved refrigerator hinge having the advantages of conversion of circular motion into linear buffer motion, stable and reliable performance, uniform stress, simple and reasonable structure, high assembling efficiency, high assembling strength, stable and reliable structure, small thrust required for opening or closing, and effective prevention of accumulation of water vapor, dirt and the like.

The purpose of the present invention is achieved through the following solution: an improved refrigerator hinge, comprising a fixed base and a hinge seat, and a hinge assembly arranged between the fixed base and the hinge seat, wherein the hinge assembly comprises a first transmission arm, a second transmission arm, a back transmission arm and a lower transmission arm; one end of the first transmission arm is hinged with the fixed base, the other end of the first transmission arm is hinged with a buffer head, one end of the back transmission arm is connected with the buffer head, the other end of the back transmission arm is hinged with the hinge seat, one end of the second transmission arm is hinged with the fixed base, the other end of the second transmission arm is hinged with the back transmission arm, one end of the lower transmission arm is hinged with the second transmission arm, and the other end of the lower transmission arm is hinged with the hinge seat; the first transmission arm is provided with an elastic buffer device, and the buffer head acts at the buffer end of the elastic buffer device for linear buffer; the fixed base is integrated with more than one assembling plate; and when the hinge is open, the second transmission arm is spanned between the fixed base and the hinge seat.

The elastic buffer device comprises a buffer frame, an elastic element and a buffer wheel, wherein the buffer wheel slides on the buffer frame, one end of the elastic element acts on the buffer frame, and the other end thereof acts on the buffer wheel for elastic reset slide.

The buffer head is provided with an eccentric smooth arc-shaped face, the arc-shaped face and the buffer wheel are squeezed each other, and the buffer wheel is rolled on the arc-shaped face.

The connecting end of the elastic buffer device is connected with the middle portion of the first transmission arm; and a first pin shaft is assembled on the first transmission arm, and the buffer end of the elastic buffer device is supported on the first pin shaft.

The assembling plate outwards extends to the side walls of the fixed base, and the assembling plate is provided with more than one fixing portion to fix and assemble the fixed base.

The assembling surface a of the assembling plate and/or the assembling surface b of the fixed base are (is) provided with antiskid mats or antiskid teeth.

The hinge point between the lower transmission arm and the second transmission arm is c, the hinge point between the lower transmission arm and the hinge seat is d, and the hinge point between the second transmission arm and the back transmission arm is e, where the distance from c to d is less than that from c to e.

A rocker transmission mechanism of the hinge of the present invention has the advantageous effects:

1. In the present invention, by arranging the elastic buffer device on the first transmission arm, the elastic buffer device can utilize the rotation around a fixed point between the buffer head and the first transmission arm to generate lateral displacement, thereby realizing the buffering of converting the circular motion into linear motion, thus preventing the elastic element from producing deformation and uneven stress due to influence of radial stress;

2. In the present invention, by integrating the assembling plate with the fixed base, the assembling procedures thereof are simplified, the assembling efficiency is increased, and the overall strength is effectively increased, making the assembling structure more stable and reliable; and

3. In the present invention, by spanning the second transmission arm between the fixed base and the hinge seat, the number of moment arms for rotating the hinge seat is effectively increased, and the thrust required for rotation when opening or closing the refrigerator door is reduced, so that the opening or closing operation of the hinge is more convenient and easier; and in addition, by spanning the second transmission arm, the number of connecting points inside the hinge can be reduced, effectively preventing accumulation of water vapor, dirt and the like, and increasing durability.

### DESCRIPTION OF DRAWINGS

FIG. 1 is a schematic diagram showing a usage state of a best embodiment of the present invention;

FIG. 2 is a breakdown drawing of the present invention;

FIG. 3 is a structural schematic diagram of an elastic buffer device of the present invention;

FIG. 4 is a local structural schematic diagram of the present invention;

FIG. 5 is a structural schematic diagram of an antiskid mat arranged on an assembling plate of the present invention; and

FIG. 6 is a structural schematic diagram of antiskid teeth arranged on an assembling plate of the present invention.

In the Figures: 1. fixed base; 11. first shaft hole; 2. hinge seat; 3. first transmission arm; 4. second transmission arm; 5. back transmission arm; 6. elastic buffer device; 61. buffer frame; 611. buffer chute; 62. elastic element; 63. buffer wheel; 64. push component; 7. buffer head; 9. assembling plate; 91. fixing portion; 10. first pin shaft; 111. second pin shaft; 12. antiskid mat; 13. antiskid teeth; 14. fastening unit.

### DETAILED DESCRIPTION

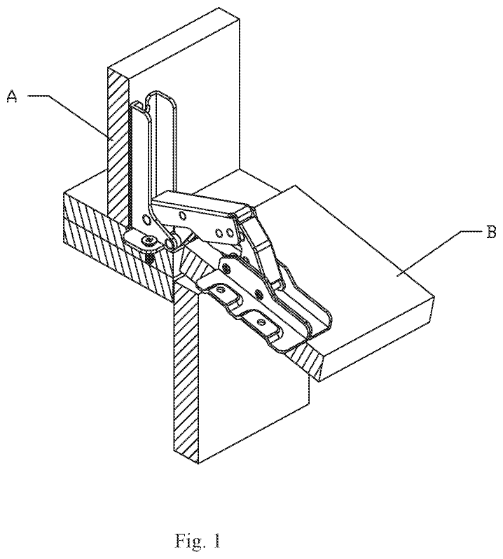

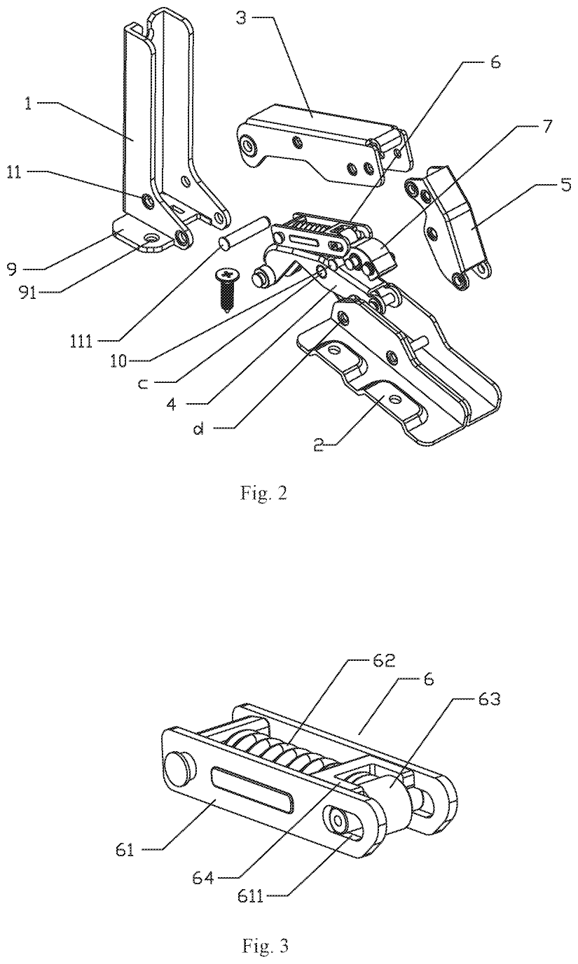

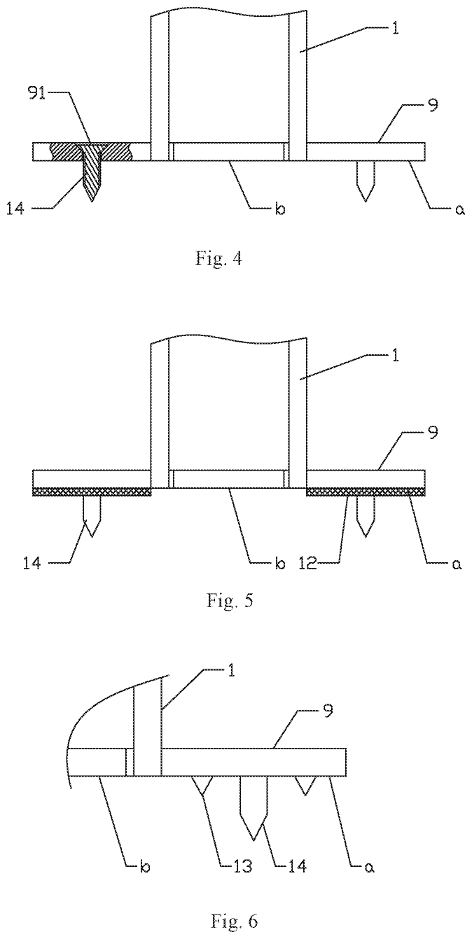

The present invention is further described in detail below in combination with the drawings. As shown in FIG. 1-FIG. 4, an improved refrigerator hinge of the present invention, comprising a fixed base 1 fixed to a refrigerator frame A and a hinge seat 2 fixed to a refrigerator door B. and a hinge assembly arranged between the fixed base 1 and the hinge seat 2, wherein the hinge assembly comprises a first transmission arm 3, a second transmission arm 4, a back transmission arm 5 and a lower transmission arm; one end of the first transmission arm 3 is hinged with a bending portion of the fixed base 1, the other end of the first transmission arm 3 is hinged with a buffer head 7, one end of the back transmission arm 5 is fixedly connected with the buffer head 7, the other end of the back transmission arm 5 is hinged with the middle portion of the hinge seat 2, one end of the second transmission arm 4 is hinged with the end of the fixed base 1, the other end of the second transmission arm 4 is hinged with the middle portion of the back transmission arm 5, one end of the lower transmission arm (not labeled in the figure) is hinged with the middle portion of the second transmission arm 4, and the other end of the lower transmission arm is hinged with the end of the hinge seat 2; the first transmission arm 3 is hinged with an elastic buffer device 6, and the buffer head 7 acts at the buffer end of the elastic buffer device 6 for linear buffer through rotation around a fixed point; the fixed base 1 is integrated with two assembling plates 9; and when the hinge is open, the second transmission arm 4 is spanned between the fixed base 1 and the hinge seat 2.

The elastic buffering device 6 of this structure can utilize the rotation around a fixed point between the buffer head 7 and the first transmission arm 3 to generate lateral displacement, thereby realizing the buffering of converting the circular motion into linear motion, thus preventing the elastic element 62 of the elastic buffer device 6 from producing deformation and uneven stress due to influence of radial stress; by integrating the assembling plate 9 with the fixed base 1, the assembling procedures thereof are simplified, the assembling efficiency is increased, and the overall strength is effectively increased, making the assembling structure more stable and reliable; and by spanning the second transmission arm 4 between the fixed base 1 and the hinge seat 2, the number of moment arms for rotating the hinge seat 2 is effectively increased, and the thrust required for rotation when opening or closing the refrigerator door B is reduced, so that the opening or closing operation of the hinge is more convenient and easier; and the number of connecting points inside the hinge can be reduced, effectively preventing accumulation of water vapor, dirt and the like, and increasing durability.

The elastic buffer device 6 comprises a buffer frame 61, an elastic element 62, a buffer wheel 63 and a push component 64, wherein a buffer chute 611 is provided at the buffer end of the buffer frame 61, and both ends of the buffer wheel 63 extend into the buffer chute 611 to slide on the buffer frame 61; the elastic element 62 is a helical spring, with one end thereof acts on the connecting end of the buffer frame 61, the other end acts on the buffer wheel 63 by the push component 64 for elastic reset and slide, and the buffer wheel 63 can be freely rolled during the period; to prevent the elastic element 62 from directly acting on the buffer wheel 63 and then affecting the rolling thereof, the push component 64 is provided, and the push component 64 acts on the rotating shaft of the buffer wheel 63, thereby avoiding the influence on same.

The surface of the buffer head 7 is provided with an eccentric smooth arc-shaped face having an eccentric characteristic, the arc-shaped face and the buffer wheel 63 are squeezed each other, and the buffer wheel 63 is rolled on the arc-shaped face; while rolling, a buffer effect is generated, which can effectively reduce friction between the two, make buffering smoother, and have a mute effect.

The connecting end of the elastic buffer device 6 is connected with the middle portion of the first transmission arm 3; and a first pin shaft 10 is assembled at the end of the first transmission arm 3, the buffer end of the elastic buffer device 6 is supported on the first pin shaft 10, and the buffer end of the elastic buffer device 6 is arranged between the first pin shaft 10 and the inner top wall of the first transmission arm 3, thereby having a compact and reliable structure and high integrity.

The fixed base 1 is arranged in an L shape, a first shaft hole 11 is provided at the bending portion thereof, a second pin shaft 111 is arranged in the first shaft hole 11, and the first transmission arm 3 is hinged with the fixed base 1 by the second pin shaft 111, thereby realizing hinging using the second pin shaft 111 and having a simple and reasonable structure.

The assembling plate 9 outwards extends to the two side walls of the fixed base 1, and the assembling plate 9 is provided with a fixing portion 91 to fix and assemble the fixed base 1. The fixing portion 91 is a through hole in which a fastening unit 14 is assembled, wherein the fastening unit 14 may be a screw, a rivet, or other parts realizing fixed connection between the fixed base 1 and the refrigerator frame A.

The fixed base 1 is in an L shape, the assembling plate 9 is arranged at the bending edge at one side, and on the premise of guaranteeing firm assembling, the assembling procedures are effectively reduced, and the assembling efficiency is increased. In addition, to further increase the stability and prevent the displacement of the fixed base 1, the assembling surface a of the assembling plate 9 is additionally provided with antiskid mats 12 (see FIG. 5) or antiskid teeth 13 (see FIG. 6).

The hinge point between the lower transmission arm and the second transmission arm 4 is c, the hinge point between the lower transmission arm and the hinge seat 2 is d, and the hinge point between the second transmission arm 4 and the back transmission arm 5 is e, where the distance from c to d is less than that from c to e. This distance ensures that when the hinge is open, one end of the second transmission arm 4 is always in the hinge seat 2, further realizing the spanning of the second transmission arm 4.

The specific embodiments are only specific embodiment with good effects of the present invention. Any rocker transmission mechanism of a hinge identical or equivalent to this structure shall be covered in the protection scope of the present invention.

What is claimed is:

1. An improved refrigerator hinge, comprising a fixed base (1) and a hinge seat (2), and a hinge assembly arranged between the fixed base (1) and the hinge seat (2), wherein the hinge assembly comprises a first transmission arm (3), a second transmission arm (4), a back transmission arm (5) and a lower transmission arm; one end of the first transmission arm (3) is hinged with the fixed base (1), the other end of the first transmission arm (3) is hinged with a buffer head (7), one end of the back transmission arm (5) is connected with the buffer head (7), the other end of the back transmission arm (5) is hinged with the hinge seat (2), one end of the second transmission arm (4) is hinged with the fixed base (1), the other end of the second transmission arm (4) is hinged with the back transmission arm (5), one end of the lower transmission arm is hinged with the second transmission arm (4), and the other end of the lower transmission arm is hinged with the hinge seat (2); the first transmission arm (3) is provided with an elastic buffer device (6), and the buffer head (7) acts at the buffer end of the elastic buffer device (6) for linear buffer, the fixed base (1) is integrated with more than one assembling plate (9); and when the hinge is open, the second transmission arm (4) is spanned between the fixed base (1) and the hinge seat (2).

2. The improved refrigerator hinge according to claim 1, wherein the elastic buffer device (6) comprises a buffer frame (61), an elastic element (62) and a buffer wheel (63), wherein the buffer wheel (63) slides on the buffer frame (61), one end of the elastic element (62) acts on the buffer frame (61), and the other end thereof acts on the buffer wheel (63) for elastic reset slide.

3. The improved refrigerator hinge according to claim 2, wherein the buffer head (7) is provided with an eccentric smooth arc-shaped face, the arc-shaped face and the buffer wheel (63) are squeezed each other, and the buffer wheel (63) is rolled on the arc-shaped face.

4. The improved refrigerator hinge according to claim 1, wherein the connecting end of the elastic buffer device (6) is hinged with the middle portion of the first transmission arm (3); and a first pin shaft (10) is assembled on the first transmission arm (3), and the buffer end of the elastic buffer device (6) is supported on the first pin shaft (10).

5. The improved refrigerator hinge according to claim 1, wherein the assembling plate (9) outwards extends to the side walls of the fixed base (1), and the assembling plate (9) is provided with more than one fixing portion (91) to fix and assemble the fixed base (1).

6. The improved refrigerator hinge according to claim 1, wherein the assembling surface a of the assembling plate (9) and/or the assembling surface b of the fixed base (1) are (is) provided with antiskid mats (12) or antiskid teeth (13).

7. The improved refrigerator hinge according to claim 1, wherein the hinge point between the lower transmission arm and the second transmission arm (4) is c, the hinge point between the lower transmission arm and the hinge seat (2) is d, and the hinge point between the second transmission arm (4) and the back transmission arm (5) is e, where the distance from c to d is less than that from c to e.
